(19) United States
(12) Patent Application Publication
(10) Pub. No.: US 2008/0134530 A1
(43) Pub. Date: Jun. 12, 2008

(54) Measuring apparatus

(76) Inventor: Eric V. Hoeppner, Clovis, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/636,733

(22) Filed: Dec. 11, 2006

(51) Int. Cl. B43L 7/10

(52) U.S. Cl. 33/416

(57) ABSTRACT

A measuring apparatus for determining the attitude of a work object, the measuring apparatus having a first element adapted to engage the work object; an instrument operable to identify the attitude of the first element during engagement of the first element with the work object; and a second element borne by the first element adapted to provide a measurement relative to the work object when the first element is in engagement with the work object.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field Of The Invention

The present invention relates to a measuring apparatus and, more particularly, to a measuring apparatus which is adapted for usage in virtually any operational environment where it is desired to determine a particular angle, attitude or other information regarding a work object. The apparatus is used to ascertain the desired data which is then employed for the specific activity involved.

(2) Description Of The Prior Art

A wide variety of environments exist in which it is necessary or useful to determine, with a desired degree of precision, the attitude, angle or the like of a work object relative to a known reference. The known reference may be, for example, vertical, horizontal, or another known reference. The known reference may also be quantitative such as a numerical reference or a reference in other data. This objective has long been known and, as a consequence, a variety of methods and devices have been conceived and developed for accomplishing this, or a similar objective, in a variety of work environments.

An acceptable margin for error, of course, depends upon the particular environment involved. For example, when used over a short distance, or for a rough approximation, precise accuracy may be of negligible importance. However, this margin of error may not be acceptable and may in fact be exacerbated by extension over greater distances, by the inaccuracy of the method or device, or otherwise where precision may be essential to the task at hand.

Furthermore, in many work environments the skill, attention to detail, available time, or adequate work conditions for the personnel responsible for obtaining the measurement may be lacking. For example, in the construction industry all of these limitations are frequently present. Therefore, the quality of the resultant project may well be adversely affected. This is frequently the case with architectural construction of all types, housing construction, surveying, earth working, road grading, aircraft manufacturing and automobile manufacturing just to name a few. Prior art efforts have been lacking in the ability to meet these objectives.

Therefore, it has long been known that it would be desirable to have a measuring apparatus which can be operated with a degree of accuracy acceptable in a wide variety of operational environments; which can be operated under a variety of adverse conditions; which can be operated by personnel with limited training or skill, limited attention to detail, or limited as to time; which can be manufactured and sold at relatively insignificant expense; which can be operated with an intuitive skill; and which is otherwise entirely successful in achieving its operational objectives.

### BRIEF SUMMARY OF THE INVENTION

Therefore, it is an object of the present invention to provide an improved measuring apparatus for use in a wide variety of operational environments.

Another object is to provide such a measuring apparatus which can be operated under adverse conditions with a precision not heretofore achieved in the art.

Another object is to provide such a measuring apparatus which has application in a wide variety of work environments such as construction, surveying, earth working, road grading and a multiplicity of other environments.

Another object is to provide such a measuring apparatus which is readily and rapidly operated to obtain the desired measurements.

Another object is to provide such a measuring apparatus which can be operated under less than optimum working conditions to achieve the measurement desired.

Another object is to provide such a measuring apparatus which can be operated intuitively by personnel not trained, or with only minimal training, in its usage.

Another object is to provide such a measuring apparatus which is durable while being precise in the information provided.

Another object is to provide such a measuring apparatus which can be manufactured and sold at minimal expense thereby making the apparatus practical for use in a multiplicity of work environments and in a plurality of numbers of units in a single work operation.

Another object is to provide such a measuring apparatus which is readily adjustable to obtain the measurement desired.

Another object is to provide such a measuring apparatus which is readily collapsible for transport from site to site and for purposes of storage.

Further objects and advantages are to provide improved elements and arrangements thereof in an apparatus for the purposes described which is dependable, economical, durable and fully effective in accomplishing its intended purposes.

These and other objects and advantages are achieved, in the preferred embodiment of the present invention, in a measuring apparatus having a first element adapted to engage the work object, an instrument for identifying the attitude of the first element during engagement of the first element with the work object, and a second element borne by the first element and operable to provide a measurement relative to the work object while the first element is in engagement with the work object.

### BRIEF DESCRIPTION OF THE SEVERAL VIEWS OF THE DRAWINGS

FIG. 1 is a fragmentary perspective view of the measuring apparatus of the present invention deployed for use in a representative operational environment in measuring the pitch of a roof.

FIG. 2 is a somewhat enlarged perspective view of the measuring apparatus deployed in an operational configuration.

FIG. 3 is a somewhat further enlarged perspective view of the measuring apparatus deployed in a collapsed configuration for transport, storage, or the like.

FIG. 4 is a fragmentary side elevational view of the measuring apparatus in the representative operational environment of FIG. 1.

FIG. 5 is a side elevation of the right side of the measuring apparatus deployed in the collapsed configuration of FIG. 3.

FIG. 6 is a side elevation of the left side of the measuring apparatus in the collapsed configuration of FIG. 3.

FIG. 7 is a top plan view of the measuring apparatus in the collapsed configuration of FIG. 3.

FIG. 8 is a bottom plan view of the measuring apparatus in the collapsed configuration of FIG. 3.

FIG. 9 is a bottom perspective view of the measuring apparatus in an open, configuration.

### DETAILED DESCRIPTION OF THE INVENTION

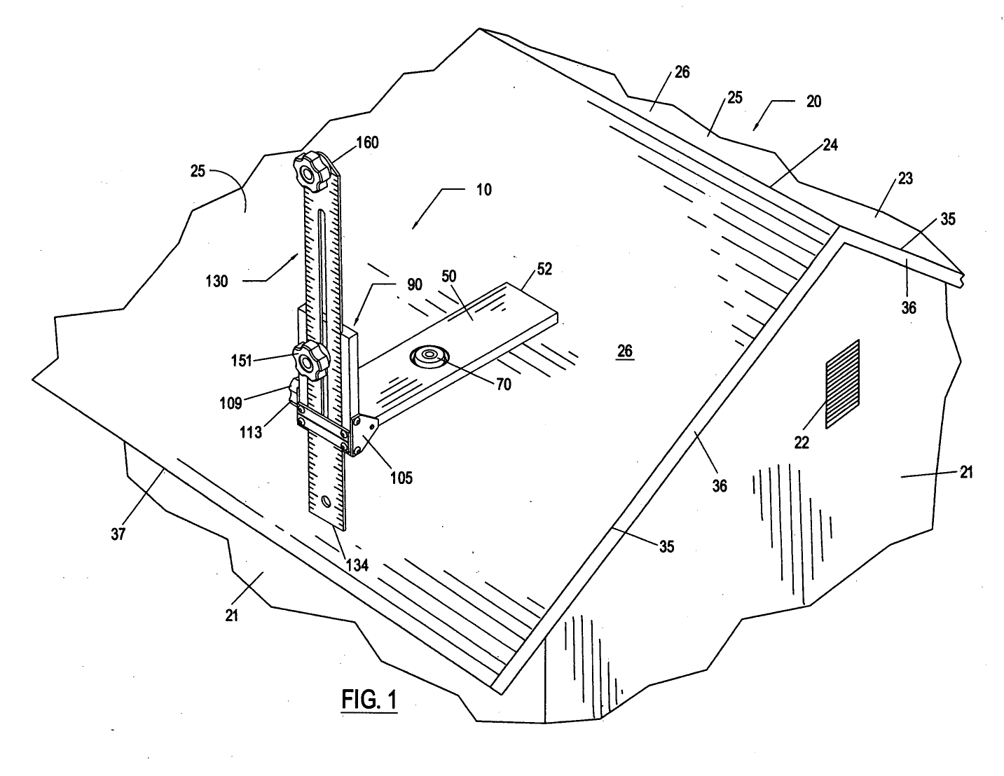

Referring more particularly to the drawings, the measuring apparatus of the present invention in generally indicated by the numeral 10 in FIG. 1.

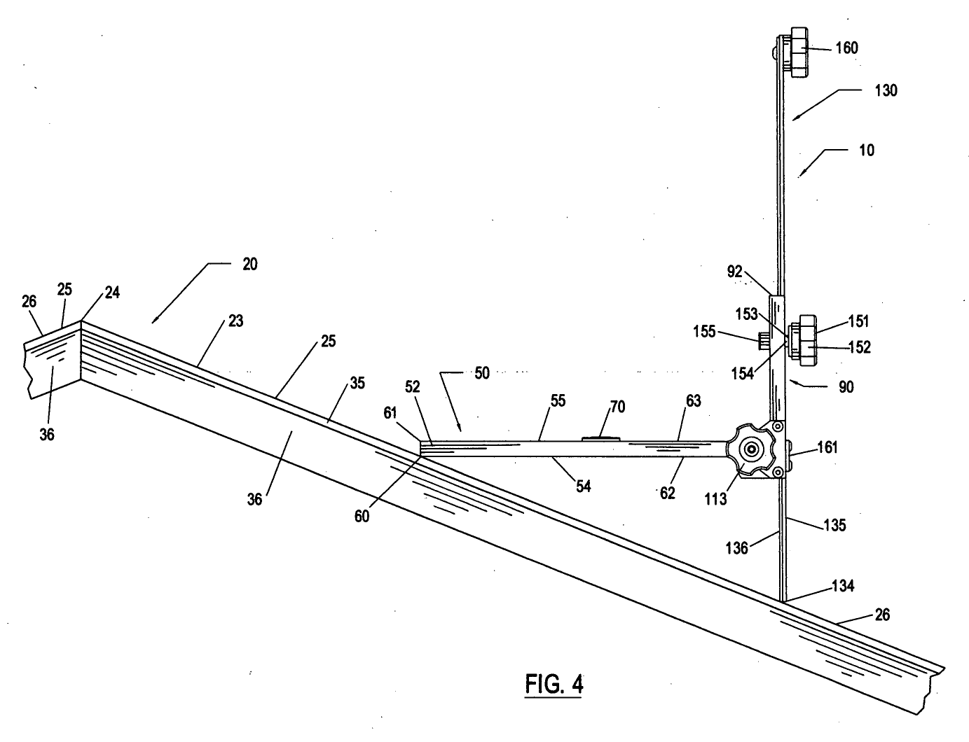

The measuring apparatus 10 can be employed in a variety of operative environments in determining the attitude of a work object. As shown in FIGS. 1 and 4, the measuring apparatus is deployed in use in a representative operative environment relative to a structure such as a house 20. As shown therein, the house has exterior walls 21, one of the walls having a vent 22 therein communicating with the attic, not shown, of the house. The exterior walls are surmounted by a roof 23. The roof of the house has a ridge or peak 24. The peak forms a juncture of downwardly sloped portions 25 of the roof. Each sloped portion of the roof has an upper surface 26 which can be composed of shingles, shakes, composition roofing material, tiles, or the like, not specifically shown.

The sloped portions 25 of the roof 23 have transverse marginal edges 35 from which extended facings 36 are mounted on and are downwardly extended therefrom. The sloped portions of the roof have longitudinal marginal edges 37 shown in FIG. 1.

The measuring apparatus 10 has a first element or first member 50 having a substantially rectangular configuration. Thus, the first member has parallel lateral sides 51. The first member has a terminal end 52 and an opposite proximal end 53. The first member has a lower surface 54 and an upper surface 55. The terminal end 52 has a lower edge 60 and an upper edge 61. Similarly, each of the lateral sides 51 have a lower edge 62 and an upper edge 63.

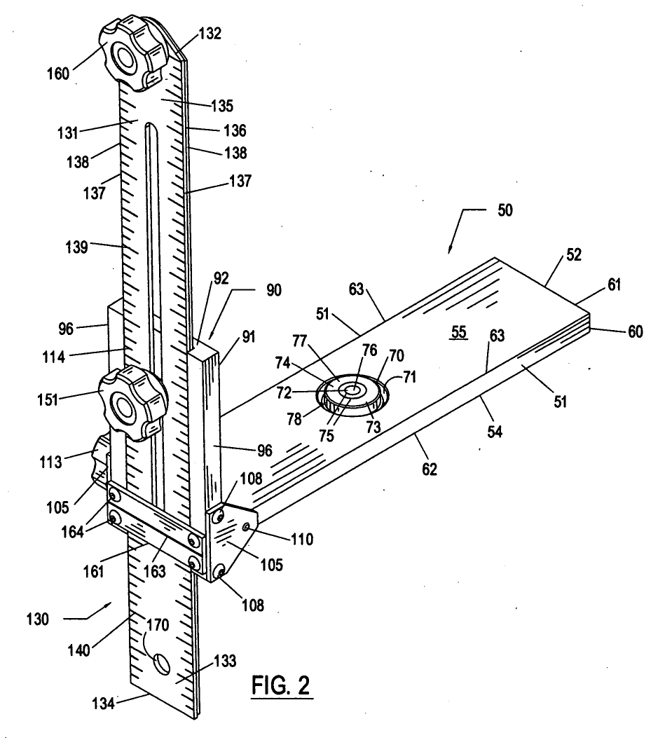

A level instrument or indicator 70 is mounted in the upper surface 55 of the first member 50, as perhaps best shown in FIG. 2. The level indicator is mounted within in a recess 71 in the upper surface 55 of the first member 50 substantially midway between the terminal end 52 and the proximal end 53 of the first member. The level indicator 70 has a base plate 72 mounted on the first member 50 within the recess 71. A cylindrical, fluid tight transparent housing 73 is mounted on the base plate within the recess and extends above the upper surface 55 of the first member a short distance. The transparent housing encloses a fluid tight chamber 74 containing a liquid, such as an oil fluid, preferably of a type which cannot be frozen at any ambient temperature. The transparent housing is inscribed on the upwardly facing surface thereof with a pair of concentric circular indicator rings 75 which are concentric to the circular upper surface of the transparent housing. The liquid within the transport housing is of such a character that it contains and maintains a single bubble 76 therewithin. The transparent housing has an upper wall 77 containing an elevated central portion 78 concentric to and bounded by the indicator rings 75. The bubble, when moved by movement of the first member to a position in the elevated central portion concentric to the indicator rings, indicates that the first member is in a level attitude both longitudinally and transversally as well as through out a range of three-hundred and sixty degrees (360°) thereabout. The range of three-hundred and sixty degrees (360°) is relative to a vertical axis of reference, not shown, passing through the bubble.

The measuring apparatus 10 has a mounting assembly generally indicated by the numeral 90 in FIG. 2. The mounting assembly has a mounting plate 91 having an upper end portion 92 and an opposite lower end portion 93. The mounting plate has an upper surface 94 and a lower surface 95. Similarly, the mounting plate has opposite lateral surfaces 96.

The mounting plate 91 is mounted for pivotal movement on the proximal end 53 of the first member 50 by a pair of substantially triangular mounting members 105 which are mounted on opposite sides of the proximal end 53 of the first member 50. Each mounting member has an outer surface 106 and an opposite inner surface 107. The mounting members are individually mounted on the lateral surfaces 96 of the mounting plate 91 by a pair of bolt or rivet assemblies 108.

The mounting members 105 are mounted on the first member 50 by a pivot assembly 109. The pivot assembly has a pivot shaft 110 which extends through a passage 111 in the proximal end 53 of the first member 50 and through corresponding aligned passages 112 in the mounting members 105. The pivot assembly 109 has a locking handle or member 113 operably connected to the pivot shaft 110. The locking member is operable by rotation in a clockwise direction, as viewed in FIG. 6, to lock the mounting plate 91 in a selected, fixed position or angle relative to the first member 50. The locking member 113, conversely, is operable by rotation thereof in a counterclockwise direction, as viewed in FIG. 6, to free the mounting plate 91 for movement about the pivot shaft 110 to any selected angle relative to the first member 50. The mounting plate 91 has a recessed track 114 in the upper surface 94 thereof extending the full length between the upper end portion 92 and the lower end portion 93. The recessed track is bounded by parallel side walls 115.

A stop block 120 is mounted on the lower surface 54 of the first member 50. The stop block has an abutment surface 121 which engages, and thereby stops further movement of the lower end portion 93 of the mounting plate 91. The abutment surface is so positioned that such engagement prevents movement of the mounting plate relative to the first member 50 beyond a right angle or, in other words, an angle of ninety degrees (90°) therebetween. This ninety degree (90°) angle therebetween is shown in FIGS. 1, 2 and 4.

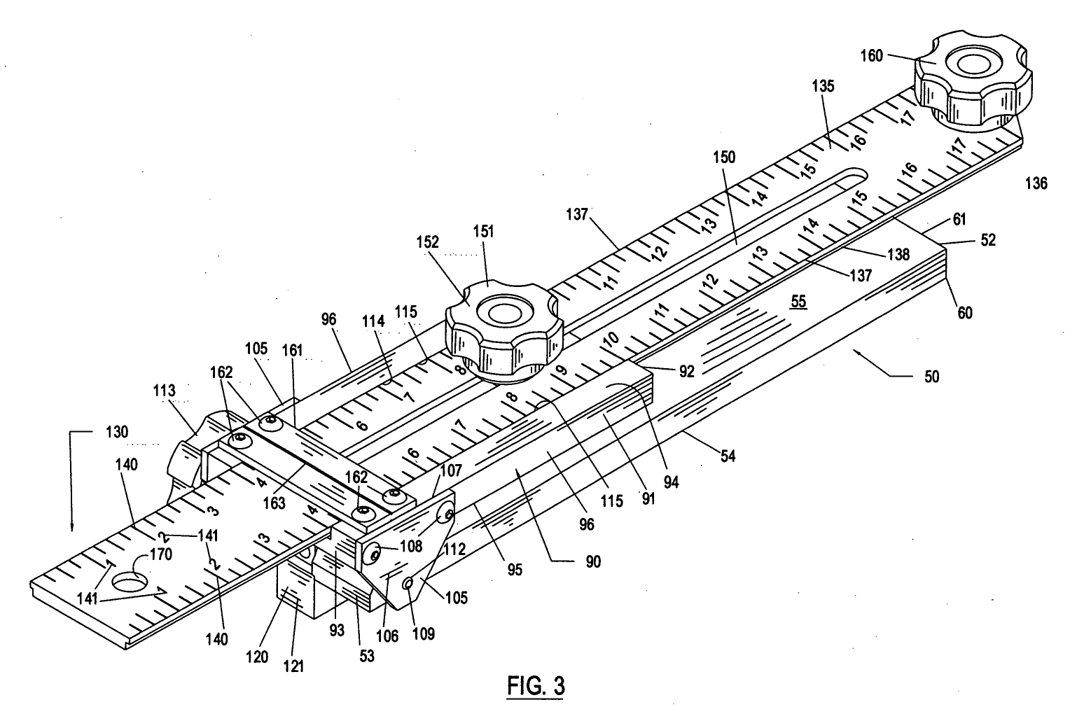

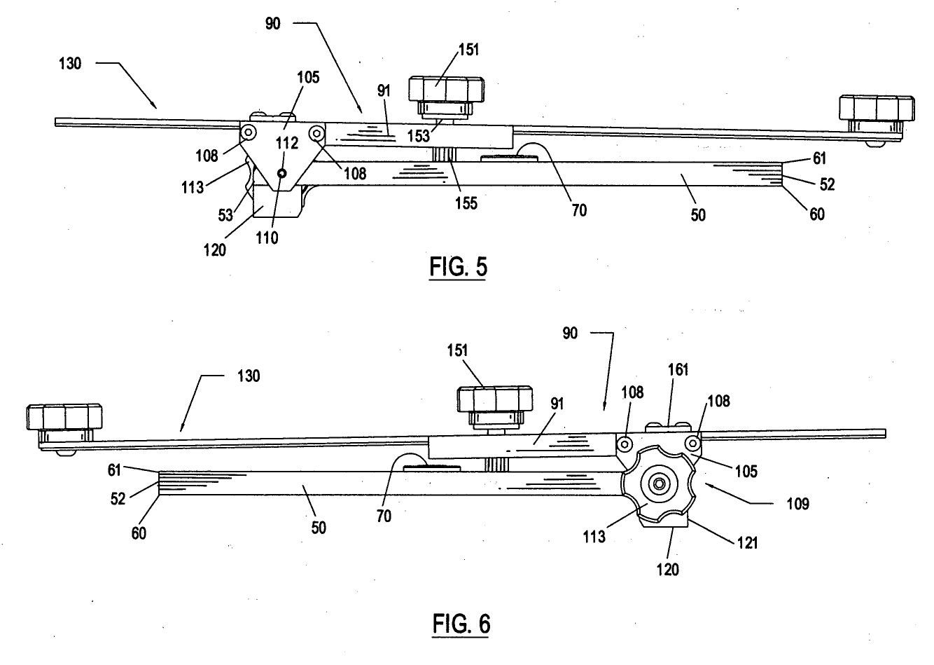

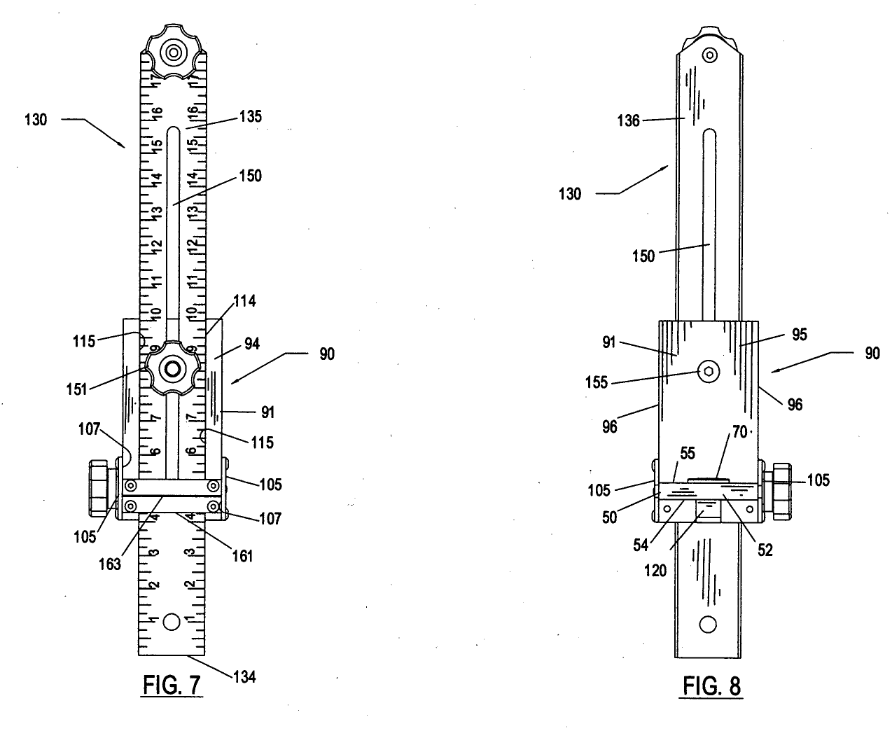

Conversely, loosening of the locking member 113 frees the mounting plate 91 for movement into the directly facing position relative to the upper surface 55 of the first member 50, as shown in FIGS. 3, 5, 6, 7 and 8, for transport, storage, or the like. The limitation on movement of the mounting plate 91 and first member 50 further toward each other will hereinafter be described. The mounting plate 91 can be locked in position at any selected angle up to ninety degrees (90°) relative to the first member by tightening the locking member by movement in a clockwise direction as viewed in FIG. 6.

The measuring apparatus 10 has a second element or member 130 mounted in the recessed track 114 of the mounting plate 91, as perhaps best shown in FIGS. 2 and 3, and as will hereinafter be discussed in greater detail. The second member has a substantially flat plate or scale 131. The scale 131 has an upper end portion 132 and an opposite lower end portion 133. The lower end portion has a straight edge 134. The scale has an upper surface 135 and an opposite lower surface 136. The scale has parallel lateral edges 137 with undercut portions 138. The upper surface 135 of the scale has mylar tape 139 adhesively attached thereto and extending between the upper end portion 132 and the lower end portion 133. The mylar tape bears upwardly facing graduations, or calibrations, 140 displaying units of measure, preferably although not necessarily, inches and portions thereof. The mylar tape bears reference numerals 141 which designate the units of measurement of the calibrations 140. The calibrations and reference numerals extend to the lateral edges, as perhaps best shown in FIG. 3.

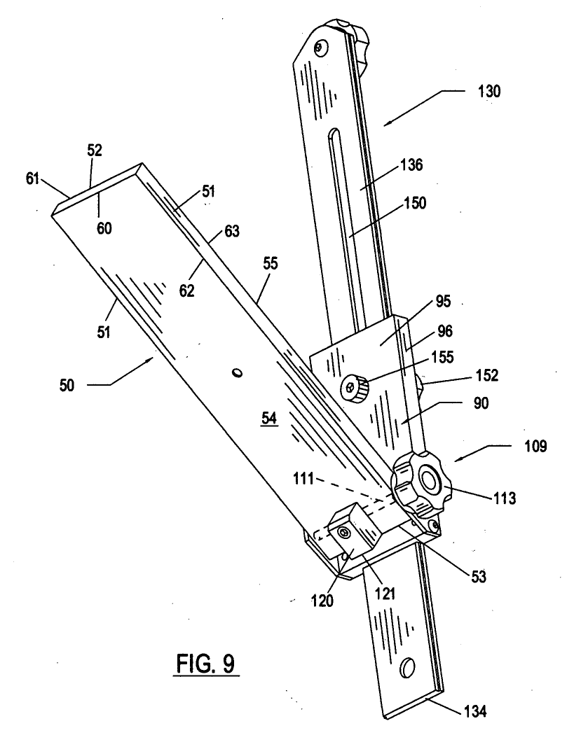

The scale 131 has a longitudinal slot 150 extending between the upper end portion 132 and the lower end portion 133. The longitudinal slot at each end thereof is set back from the upper end portion and lower end portion respectively a given distance. The longitudinal slot extends longitudinally between the calibrations 140 on opposite sides of the scale. A locking assembly 151 extends through the longitudinal slot and through mounting plate 91, as shown in FIGS. 4, 5, 6, 7 and 8. The locking assembly 151 has a handle 152 with a screw hole 153 in the bottom thereof having internal female screwthreads therewithin. A socket head screw 154 is screw threadably received in the screw hole 153 of the handle 152. The socket head screw has a screw head 155 which extends outwardly from the lower surface 95 of the mounting plate 91, as shown in FIGS. 4, 5, 6, 8 and 9.

A handle 160 is mounted on and extends outwardly from the upper end portion 132 of the upper surface 135 of the scale 131. The handle is fixed relative to the scale. An indicator plate 161 is mounted on the mounting plate 91 by four (4) mounting screws 162. The indicator plate 161 is transparent and is disposed in covering relation to the scale 131. The indicator plate has a sight line 163 extending there across at right angles to the scale for purposes of reading the distance between the straight edge 134 and the sight line. A passage 170 extends through the scale 131 adjacent to the straight edge 134 of the lower end portion 133 thereof.

### OPERATION

The operation of the described embodiment of the subject invention is believed to be clearly apparent and is briefly summarized at this point.

As previously stated, the measuring apparatus 10 of the present invention can be employed in a wide variety of operative environments for measuring the attitude of a work object. A representative operative environment for the measuring apparatus of the present invention is shown in FIGS. 1 and 4. In this environment, the measuring apparatus is used for the purpose of measuring the pitch of the upper surface 26 of the sloped portion 25 of the roof 23. As shown in FIGS. 3, 5, 6, 7 and 8, the measuring apparatus is in a collapsed configuration. In the collapsed configuration the measuring apparatus can readily be transported, stored, or the like. For example, in the operative environment of FIGS. 1 and 4, the measuring apparatus must be transported by the operator on to the upper surface 26 of the sloped portion 25 of the roof 23. Reaching this location may require the operator to climb a ladder, not shown, to reach the upper surface and then to climb upwardly on the upper surface of the sloped portion to a position, such as shown in FIGS. 1 and 4. During such transport the measuring apparatus can conveniently be carried in the collapsed configuration shown in FIGS. 3, 5, 6, 7 and 8.

In this collapsed configuration, the mounting assembly 90 and the mounting plate 91 thereof are retained in a relationship to each other shown in FIGS. 3, 5, 6, 7 and 8 with the mounting assembly and second member directly facing the first member 50. This collapsed configuration is releasably secured and maintained by the tightening of the locking member 113. Rotation of the locking member in a clockwise direction as shown in FIG. 6 with engagement of the screw head 155 with the upper surface 55 of the first member 50 achieved the securing of the measuring apparatus in the collapsed configuration. Such engagement of the screw head maintains the spacing of the mounting plate 91 relative to the level indicator 70 to avoid damage to the level indicator. In this collapsed configuration, the measuring apparatus can conveniently be carried to the position on the sloped portion 25 of the roof 23 shown in FIGS. 1 and 4. With the locking member 113 in this locked position, the collapsed configuration of the measuring apparatus is maintained without the possibility of unintentional release therefrom.

Upon reaching the desired location on the sloped portion 25 of the roof 23, the operator adjusts the measuring apparatus 10 from the collapsed configuration heretofore described to the operational configuration shown in FIGS. 1, 2 and 4. This is achieved by loosening the locking member 113 by rotation of the locking member in a counterclockwise direction as viewed in FIG. 4. The first member 50, together with the mounting assembly 90, and the second member 130 are thus unlocked relative to each other. In otherwords, they are released relative to each other for pivotal movement about the pivot shaft 110.

The operator then pivots the mounting assembly 90 and the second member 130 thereof to an angle of ninety degrees (90°) relative to the first member 50. This precise angle is reached when the abutment surface 121 of the stop block 120 engages the lower end portion 93 of the mounting assembly 90. This engagement prevents movement beyond the ninety degree (90°) angle and indicates to the operator that this ninety degree (90°) relationship has been achieved. The operator then tightens the locking member 113 by movement thereof in a clockwise direction, as viewed in FIG. 4. When the locking member has been tightened in this ninety degree (90°) relationship, the measuring apparatus 10 is ready for use.

In the operational environment shown in FIGS. 1 and 4, the operator then positions the lower edge 60 of the first member 50 in engagement with the upper surface 26 of the sloped portion 25 of the roof 23. The first member is positioned so that it extends in the direction of the peak 24 of the roof with the lower edge 60 thereof parallel to the peak of the roof.

The locking assembly 151 is then loosened to free the scale 131 for movement within the recessed track 114 of the mounting plate 91. Loosening of the locking assembly is achieved by rotation of the handle 152 in a counterclockwise direction, as viewed in FIG. 2. The scale 131 is then moved downwardly in the recessed track 114 until the straight edge 134 engages the upper surface 26 of the sloped portion 25 of the roof 23, as shown in FIGS. 1 and 4.

The operator then positions the first member 50 in a level attitude. This is accomplished by reference to the level indicator 70. More specifically, such a level attitude is achieved by movement of the first member until the bubble 76 of the level indicator 70 is centrally located, or concentric to, the indicator rings 75 thereof. When this is achieved while the lower edge 60 and straight edge 134 are in engagement with the upper surface 26 of the sloped portion 25 of the roof 23, as shown in FIGS. 1 and 4, the locking assembly 151 is tightened to lock the scale 131 in this position in the recessed track 114. Such tightening of the locking member is accomplished by rotation of the handle 152 in a clockwise direction, as viewed in FIG. 2, until the handle is fully tightened and the scale 131 is locked in position in the recessed track 114. Thus, the configuration shown in FIGS. 1 and 4 is achieved with the first member 50 in a level attitude, with the scale 131 at an angle of ninety degrees (90°) thereto and with the lower edge 60 and straight edge 134 in engagement with the upper surface 26 of the sloped portion 25 of the roof 23.

While the foregoing steps are completed by the relatively lengthy description as above set forth, in practice these steps are rapidly and conveniently performed.

The operator then uses the indicator plate 161 to read the scale 131. The indicator plate, being transparent, permits the operator to see the calibrations 140 and reference numerals 141 therethrough. The operator uses the sight line 163 of the indicator plate 161 to note which calibration and reference numeral are precisely aligned with the sight line. This achieves measurement of the distance between the sight line and the straight edge 134 of the scale 131, or, in other words, the distance between the lower surface 54 of the first member 50 and the upper surface 26, of the sloped portion 25 of the roof 23 in vertical alignment along the scale 131. This measurement is then employed to calculate the pitch of the roof 23.

Therefore, the measuring apparatus of the present invention can be operated with a degree of accuracy permitting use in a wide variety of operational environments to determine the attitude of a work object; is particularly well suited to measuring the pitch of a roof; can be operated under a wide variety of adverse conditions; can be operated by personnel with limited training or skill, limited attention to detail, or limited as to time; can be manufactured and sold at relatively insignificant expense; can be operated with intuitive skill; and is otherwise entirely successful in achieving its operational objectives.

Although the invention has been herein shown and described in what is conceived to be the most practical and preferred embodiment, it is recognized that departures may be made therefrom within the scope of the invention which is not to be limited to the illustrative details herein disclosed.

Having described my invention, what I claim as new and desire to secure by Letters Patent is:

1. A measuring apparatus for determining the attitude of a work object, the measuring apparatus comprising a first element adapted to engage the work object; an instrument operable to identify the attitude of the first element during engagement of the first element with the work object; and a second element borne by the first element adapted to provide a measurement relative to the work object when the first element is in engagement with the work object.

2. The measuring apparatus of claim 1 wherein said instrument is operable to identify the attitude of the first element, while the first element is in engagement with the work object, relative to a known reference.

3. The measuring apparatus of claim 2 wherein the known reference is a horizontal attitude.

4. The measuring apparatus of claim 3 wherein said known reference is level within said horizontal attitude.

5. The apparatus of claim 2 wherein said level instrument is operable to register the attitude of the first element, while in engagement with the work object, relative to level.

6. The apparatus of claim 5 wherein said level instrument is operable to indicate when the first element is level through out a range of three-hundred and sixty degrees (360°) relative to a vertical axis of reference.

7. The measuring apparatus of claim 6 wherein said level instrument has a circular transparent housing having an elevated central portion and containing a fluid therewithin containing a bubble which moves within the fluid to said elevated central portion of the housing when the first element is level.

8. The measuring apparatus of claim 7 wherein said housing has at least one circular ring displayed on said elevated central portion of the housing to register when the bubble is centered within the elevated central portion thereby to indicate when said first element is level.

9. The measuring apparatus of claim 7 wherein said second element has a mounting assembly mounted on the first element and having a scale to indicate said measurement relative to the work object.

10. The measuring apparatus of claim 9 wherein the scale is slideable with respect to the mounting assembly.

11. The measuring apparatus of claim 10 wherein said scale has calibrations thereon to indicate said measurement relative to the work object.

12. The measuring apparatus of claim 11 wherein said mounting assembly is pivotally mounted on the first element moveable from an operational position relative to the first element to a collapsed position facing the first element.

13. The measuring apparatus of claim 12 including means for stopping said mounting assembly in said operational position relative to the first element and means for releasably locking said first element in said operational position.

14. The measuring apparatus of claim 13 wherein said operational position is approximately at a ninety degree (90°) angle relative to the first element.

15. The measuring apparatus of claim 14 wherein said elevated central portion of the level instrument is circumscribed by an indicator ring operable to indicate when said bubble is centered within said circumscribing ring to indicate when the first element is level relative to a vertical axis of reference extending therethrough so as to indicate level throughout 360 degrees (360°) at right angles to the vertical axis of reference.
